(19) United States
(12) Patent Application Publication
(10) Pub. No.: US 2007/0297807 A1
(43) Pub. Date: Dec. 27, 2007

(54) NOISE MITIGATION IN ANALOG OPTICAL TRANSMISSION SYSTEMS USING POLARIZATION SCRAMBLER

(76) Inventors: Yihong Chen, Naperville, IL (US); Fernando X. Villarruel, Joliet, IL (US); Daniel M. Ott, Batavia, IL (US)

Correspondence Address: Scientific-Atlanta, Inc.;Intellectual Property Dept., MS 4.3.518, 5030 Sugarloaf Parkway, Lawrenceville, GA, 30044, US

(21) Appl. No.: 11/426,794

(22) Filed: Jun. 27, 2006

(51) Int. Cl. H04B 10/00

(52) U.S. Cl. 398/158

(57) ABSTRACT

The present invention is directed towards systems and methods that include an optical polarization scrambler or depolarizer after the optical transmitter. In this manner, the optical signal is depolarized. Accordingly, the noise peaks that were translated from Guided Acoustic-Wave Brillouin Scattering (GAWBS) by the devices with polarization dependent loss or gain is mitigated in order to have little effect on the quality of the RF signal carried by lightwave.

### FIELD OF THE INVENTION

This invention relates generally to fiber optic communications systems, such as cable television networks, and more specifically to an optical communications system having an analog and QAM transport.

### BACKGROUND OF THE INVENTION

A broadband communications system, such as a two-way hybrid fiber/coaxial (HFC) system is used for transmitting video/audio, voice, and data signals. The communications system includes headend equipment for generating RF frequency signal and for imprinting the RF signal into optical carriers that are transmitted in the forward, or downstream, direction along optical fiber. The frequency band for the downstream signals is generally in a range from 45 MHz (Mega Hertz) to 1 GHz (Giga Hertz), and the frequency range for upstream signals is in a range from 15 MHz to about 40 MHz. Typically, the optical portion of the communications system utilizes passive and active devices along the transport routes to provide signals to a final distribution portion of the system. Subsequently, the RF (radio frequency) signals are extracted from optical carriers for final transmission to the subscribers through coaxial cable.

Inherent in the optical transmission fiber of the communications system, there is a forward Brillouin scattering with frequency shifting, which is known as Guided Acoustic-Wave Brillouin Scattering (GAWBS). In optical fiber, acoustic modes, such as intrinsic vibration and phonons, are guided by the cylindrical structure. The acoustic modes correspond to the radially and circumferentially propagating phonons that produce uniaxial strain or dilatation at the core. The resulting oscillatory strain and density fluctuations cause phase and polarization modulation of the confined optical field. The guided acoustic wave scatters the optical signals to the forward direction and causes a frequency shift of the optical light. This frequency shift is mostly in the range from about 50 MHz to about 800 MHz and it overlaps with the RF frequency range from about 20 MHz to 1 GHz. The scattered light with shifted frequency travels along with the unscattered light signal in optical fiber and it results in a degraded signal-to-noise ratio (SNR) or carrier-to-noise ratio (CNR). What is needed, therefore, is a method and system of mitigating the GAWBS noise that affects the transport of analog signals.

### BRIEF DESCRIPTION OF THE DRAWINGS

FIG. 1 is a block diagram illustrating an example of a conventional ring-type broadband communications system, such as a two-way hybrid/fiber coaxial (HFC) network.

FIG. 2 is a block diagram of a simplified optical transmission system that is suitable for use in the communications system of FIG. 1.

FIG. 3 illustrates a GAWBS spectrum in a typical optical link with SMF-8 optical fiber.

FIG. 4 is a block diagram of an optical transmission system including a depolarizer that is used in order to offset polarization dependent loss (PDL) in accordance with the present invention.

### DETAILED DESCRIPTION OF A PREFERRED EMBODIMENT

The present invention will be described more fully hereinafter with reference to the accompanying drawings in which like numerals represent like elements throughout the several figures, and in which an exemplary embodiment of the invention is shown. This invention may, however, be embodied in many different forms and should not be construed as being limited to the embodiments set forth herein; rather, the embodiments are provided so that this disclosure will be thorough and complete, and will fully convey the scope of the invention to those skilled in the art. All examples given herein, therefore, are intended to be non-limiting and are provided in order to help clarify the description of the invention.

The present invention is directed towards an optical communications system including a depolarizer or polarization scrambler. Placement of a depolarizer or a polarization scrambler in the optical system mitigates the negative effect of GAWBS noise peaks on the transmission of optical signals. Analog video and QAM transmission are most susceptible to those noise peaks and as a result the signal quality is degraded. It will be appreciated that noise peaks generated by GAWBS in a digital transmission system are usually not picked up by the transmitted signal, and so they do not have a significant impact on the quality of the transmission. A general overview of a typical communications system is described herein below.

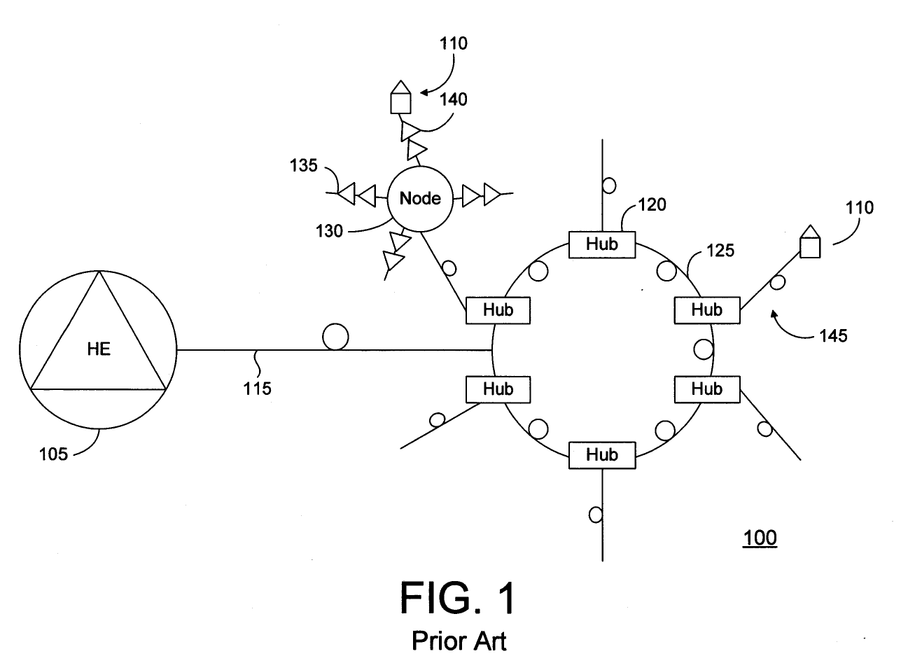

FIG. 1 is a block diagram illustrating an example of a conventional ring-type broadband communications system, such as a two-way hybrid/fiber coaxial (HFC) network. It will be appreciated that other networks exist, such as a star-type network. These networks may be used in a variety of systems, including, for example, cable television networks, voice delivery networks, and data delivery networks to name but a few. The broadband signals transmitted over the networks include multiple information signals, such as video, voice, audio, and data, each having different frequencies. Headend equipment included in a signal source, or a headend facility 105, receives incoming information signals from a variety of sources, such as off-air signal source, a microwave signal source, a local origination source, and a satellite signal source and/or produces original information signals at the facility 105. The headend 105 processes these signals from the sources and generates forward, or downstream, broadcast signals that are delivered to a plurality of subscriber equipment 110. The broadcast signals can be digital or analog signals and are initially transported via optical fiber 115 using any chosen transport method, such as SONET, gigabit (G) Ethernet, 10 G Ethernet, or other proprietary digital transport methods. The broadcast signals are typically provided in a forward bandwidth, which may range, for example, from 45 MHz to 1 GHz. The information signals may be divided into channels of a specified bandwidth, e.g., 6 MHz, that conveys the information. The information is in the form of carrier signals that transmit the conventional television signals including video, color, and audio components of the channel. Also transmitted in the forward bandwidth may be telephony, or voice, signals and data signals.

Optical transmitters (not shown), which are generally located in the headend facility 105, convert the electrical broadcast signals into optical broadcast signals. In most networks, the first communication medium 115 is a long haul segment that transports the signals typically having a wavelength in the 1550 nanometer (nm) range. The first communication medium 115 carries the broadcast optical signal to hubs 120. The hubs 120 may include routers or switches to facilitate routing the information signals to the correct destination location (e.g., subscriber locations or network paths) using associated header information. The optical signals are subsequently transmitted over a second communication medium 125. In most networks, the second communication medium 125 is an optical fiber that is typically designed for shorter distances, and which transports the optical signals over a second optical wavelength, for example, in the 1310 nm range.

From the hub 120, the signals are transmitted to an optical node 130 including an optical receiver and a reverse optical transmitter (not shown). The optical receiver converts the optical signals to electrical, or radio frequency (RF), signals for transmission through a distribution network. The RF signals are then transmitted along a third communication medium 135, such as coaxial cable, and are amplified and split, as necessary, by one or more distribution amplifiers 140 positioned along the communication medium 135. Taps (not shown) further split the forward RF signals in order to provide the broadcast RF signals to subscriber equipment 110, such as set-top terminals, computers, telephone handsets, modems, televisions, etc. It will be appreciated that only one subscriber location 110 is shown for simplicity, however, each distribution branch may have as few as 500 or as many as 1000 subscriber locations. Additionally, those skilled in the art will appreciate that most networks include several different branches connecting the headend facility 105 with several additional hubs, optical nodes, amplifiers, and subscriber equipment. Moreover, a fiber-to-the-home (FTTH) network 145 may be included in the system. In this case, optical fiber is pulled to the curb or directly to the subscriber location and the optical signals are not transmitted through a conventional RF distribution network.

In a two-way network, the subscriber equipment 110 generates reverse RF signals, which may be generated for a variety of purposes, including video signals, e-mail, web surfing, pay-per-view, video-on-demand, telephony, and administrative signals. These reverse RF signals are typically in the form of modulated RF carriers that are transmitted upstream in a typical United States range from 5 MHz to 40 MHz through the reverse path to the headend facility 105. The reverse RF signals from various subscriber locations are combined via the taps and passive electrical combiners (not shown) with other reverse signals from other subscriber equipment 110. The combined reverse electrical signals are amplified by one or more of the distribution amplifiers 140 and generally converted to optical signals by the reverse optical transmitter included in the optical node 130 before being transported through the hub ring and provided to the headend facility 105.

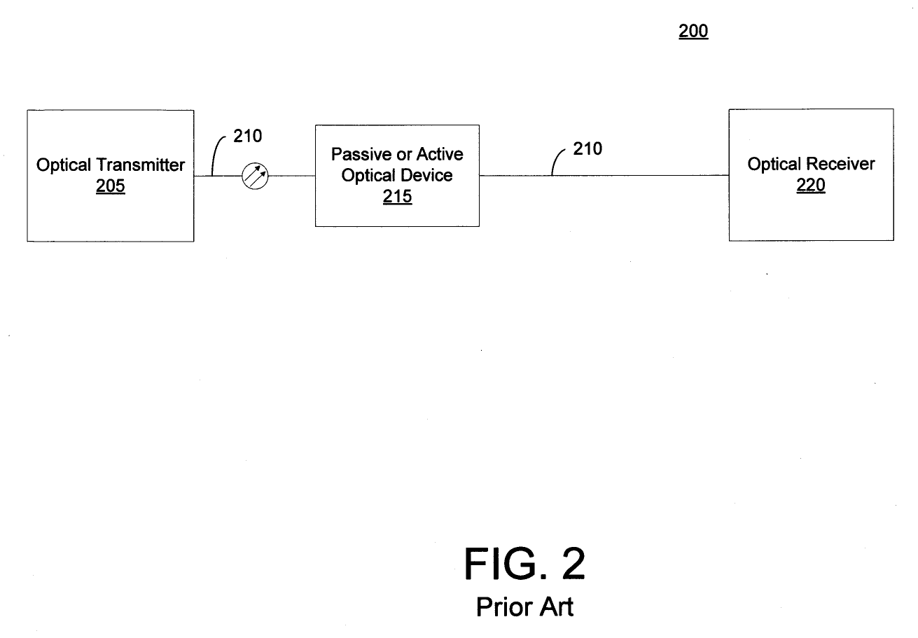

FIG. 2 is a block diagram of a simplified optical transmission system 200 that is suitable for use in the communications system of FIG. 1. A polarized optical source, transmitter 205, converts the electrical signals into optical signals before transmission through the communications system 200. The optical signals are then transmitted along an optical fiber 210. Passive or active optical devices 215 amplify or pass the signals along as necessary. An optical receiver 220 receives the optical signals for conversion to electrical signals for further transmission.

The optical fiber 210 and the passive and/or active devices 215 inherently all produce, or generate, polarization dependent loss (PDL) or polarization dependent gain (PDG), more or less. As a result, the optical devices 205, 210, 215 generate a local oscillator that interacts with the depolarized scattered light at the receiver and produces a heterodyne signal, thereby imprinting a GAWBS signature onto the RF signals in the RF domain.

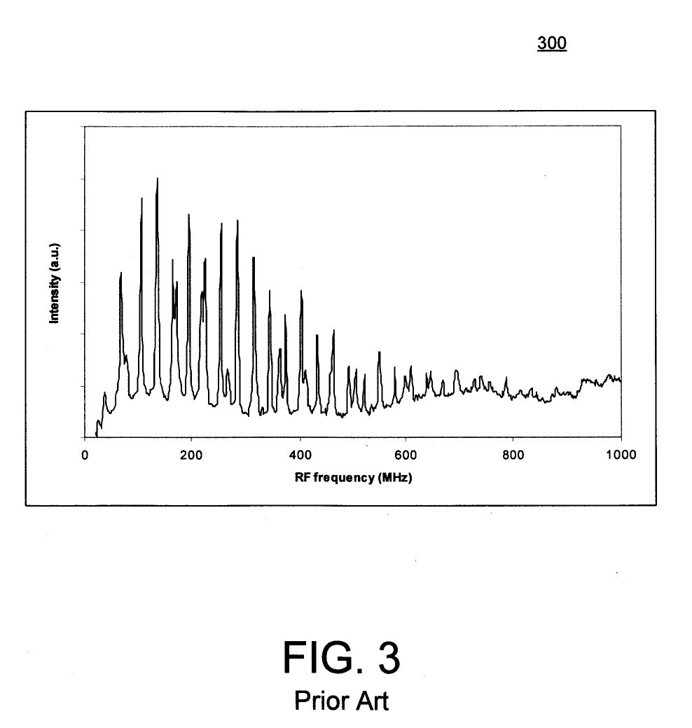

FIG. 3 illustrates a GAWBS spectrum 300 in a typical optical link with SMF-8 optical fiber. As can be seen in the spectrum 300, the GAWBS noise peaks are mainly in the frequency range from 20 MHz to 1 GHz. The higher the PDL or the PDG is in the devices, the more efficient the heterodyne detection and, therefore, the higher the GAWBS noise peaks. Additionally, in a communications system with multiple fiber sections, many optical amplifiers and other passive and/or active components, GAWBS noise accumulates along the transmission link. One solution to reducing the GAWBS noise peaks is to decrease the PDL or PDG of the optical devices used in the optical links. However, there is a limit as to how much of this can be done in practice due to limited or no availability of zero-PDL devices.

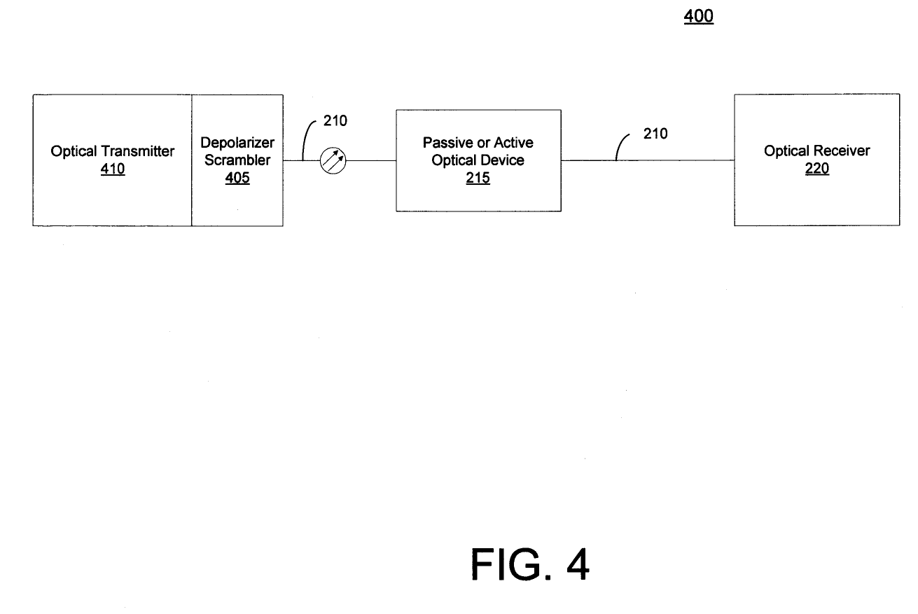

FIG. 4 is a block diagram of an optical transmission system 400 including a polarization scrambler or a depolarizer 405 that is used to change the optical signal from a polarized state to an unpolarized state. It will be appreciated that PDL of an optical device does not have any effect on unpolarized light. Accordingly, the GAWBS noise peaks are mitigated in the RF domain. As shown in FIG. 4, a depolarizer 405 is placed immediately after the optical transmitter 410. Alternatively, the depolarizer 405 may be built into the optical transmitter 410. The depolarizer 405 may also be placed anywhere in the optical link to reduce GAWBS noise, but ideally, the depolarizer 405 should be placed as close to the optical transmitter 410 as possible.

Since PDL takes advantage of organized or polarized light, it is able to transfer the noise into the RF domain that is shown as the GAWBS noise peaks. In accordance with the present invention, the polarization scrambler or depolarizer 405 scrambles the light from the optical transmitter 410. The depolarized light is then transmitted downstream to the receiver 220. Advantageously and in accordance with the present invention, the unpolarized light does not cause any effect at the device with polarization dependent loss; therefore, the GAWBS does not transfer noise into the RF domain.

The Detailed Description of a Preferred Embodiment set forth above is to be regarded as exemplary and not restrictive, and the breadth of the invention disclosed herein is to be determined from the following claims as interpreted with the full breadth permitted by the patent laws.

1. An optical transmitter for providing an analog optical signal, the optical transmitter comprising:
a depolarizer for depolarizing the optical light, wherein the depolarizer mitigates the effect of a noise signal on the analog optical signal.

2. The optical transmitter of claim 1, wherein the optical transmitter provides at least one of an analog video and a quadrature amplitude modulation (QAM) radio frequency (RF) signal in a frequency range from 50 MHz to 1 GHz.

3. The optical transmitter of claim 1, wherein the noise signal is produced by one of polarization dependent loss and polarization dependent gain of at least one of an optical amplifier, an optical receiver, and an optical fiber span and other optical components.

4. A method for providing an optical signal, the method comprising the steps of:
providing an analog modulated optical signal; and
depolarizing the analog modulated optical signal to provide a depolarized analog modulated optical signal, wherein the depolarizing step mitigates a noise signal.

5. The method of claim 4, wherein the noise signal is produced by one of polarization dependent loss and polarization dependent gain of at least one of an optical amplifier, an optical receiver, and an optical fiber span and other optical components.

6. The method of claim 4, wherein the depolarized analog modulated optical signal is transmitted in a frequency range from 50 MHz to 1 GHz.

7. An optical link for providing an optical signal, the optical link comprising:
an optical transmitter for providing optical light, wherein the optical light comprises an analog and QAM radio frequency (RF) signal; and
a depolarizer for depolarizing the optical light, wherein the depolarizer mitigates the effect of a noise signal inserted by optical equipment located in the optical link.

8. The optical link of claim 7, wherein the optical transmitter provides analog video and quadrature amplitude modulation (QAM) radio frequency (RF) signals in a frequency range from 50 MHz to 1 GHz.

9. The optical link of claim 7, wherein the optical equipment comprises:
at least one section of optical transmission fiber;
at least one optical amplifier; and
at least one optical receiver.

10. The optical link of claim 9, wherein the depolarizer is located anywhere throughout the at least one section of optical transmission fiber for the purpose of suppressing the noise signal.

11. The optical link of claim 7, wherein the optical transmitter and the depolarizer are comprised in a single integrated device.

12. A communications system for transmitting video, voice, and data signals, the communications system including devices that display unwanted noise signals in a radio frequency (RF) domain, the communications system comprising:
at least one section of optical transmission fiber;
an optical transmitter for providing optical light;
at least one optical amplifier for amplifying the optical light;
at least one optical receiver for receiving the optical light,
wherein the at least one section of optical transmission fiber, the at least one optical amplifier, and the at least one optical receiver generates a noise signal due to at least one of polarization dependent loss and polarization dependent gain; and
a depolarizer for depolarizing the optical light to provide a depolarized optical light, wherein depolarizing the optical light mitigates the generated noise signal.

13. The communications system of claim 12, wherein the optical transmitter and the depolarizer are comprised in a single integrated device.

14. The communications system of claim 12, wherein the depolarizer is located in each of the at least one section of optical transmission fiber.

15. The communications system of claim 12, wherein the optical transmitter provides at least one of an analog video and a QAM RF signal in a frequency range from 50 MHz to 1 GHz.

16. The communications system of claim 12, wherein the noise signal is produced by one of polarization dependent loss and polarization dependent gain of at least one of the optical amplifier, the at least one optical receiver, and the at least one section of optical communications fiber.
